(19) United States
(12) Patent Application Publication
(10) Pub. No.: US 2022/0208189 A1
(43) Pub. Date: Jun. 30, 2022

(54) INFORMATION PROCESSING DEVICE AND INFORMATION PROCESSING METHOD

(71) Applicant: SONY GROUP CORPORATION, TOKYO (JP)

(72) Inventor: YASUNARI HASHIMOTO, TOKYO (JP)

(21) Appl. No.: 17/606,806

(22) PCT Filed: Mar. 30, 2020
(86) PCT No.: PCT/JP2020/014683

§ 371 Date: Oct. 27, 2021

(30) Foreign Application Priority Data
May 8, 2019 (JP) 2019-088059

(51) Int. Cl. G10L 15/22; G10L 25/78; G10L 15/08; G10L 15/01

(52) U.S. Cl. CPC G10L 15/22; G10L 25/78; G10L 2015/227; G10L 15/01; G10L 2015/088; G10L 15/08

(57) ABSTRACT

The risk of mishearing by users in an environment where important information is transmitted is reduced.

A voice segment detection unit detects a voice segment from an environmental sound. A user relevance determination unit determines whether voice in the voice segment is related to a user. For example, the user relevance determination unit extracts keywords related to actions from the voice in the voice segment, and determines whether the voice in the voice segment is related to the user on the basis of the relevance of the extracted keyword to the user's actions. A presentation control unit controls presentation of the voice related to the user. For example, the presentation control unit controls the presentation of the voice related to the user when the user is in a mishearing mode.

### TECHNICAL FIELD

The present technology relates to an information processing device and an information processing method, and more particularly to an information processing device and an information processing method for reducing the risk of mishearing by a user.

### BACKGROUND ART

For example, PTL 1 proposes a technique of presenting a message from another user when the owner of a tablet terminal approaches, if a message from the other user is registered.

### CITATION LIST

### Patent Literature

[PTL 1]
JP 2014-186610 A

### SUMMARY

### Technical Problem

The technique described in PTL 1 does not reduce the risk of mishearing in an environment where important information is transmitted, such as an airport or a station.

An object of the present technology is to reduce the risk of mishearing by users in an environment where important information is transmitted by voice.

### Solution to Problem

The concept of the present technology relates to an information processing device including: a voice segment detection unit that detects a voice segment from an environmental sound, a user relevance determination unit that determines whether voice in the voice segment is related to a user, and a presentation control unit that controls presentation of the voice in the voice segment related to the user.

In the present technology, the voice segment detection unit detects the voice segment from the environmental sound. The user relevance determination unit determines whether the voice in the voice segment is related to the user. Then, the presentation control unit controls the presentation of the voice related to the user. For example, the presentation control unit may control the presentation of the voice related to the user when the user is in a mishearing mode.

For example, the user relevance determination unit may extract keywords related to actions from the voice in the voice segment, and determine whether the voice in the voice segment is related to the user on the basis of relevance of the extracted keywords to actions of the user. In this way, it is possible to satisfactorily determine whether the voice in the voice segment is related to the user.

In this case, for example, the user relevance determination unit may use the extracted keywords after performing quality assurance processing. For example, the quality assurance may include compensation for missing information or correction of incorrect information. Further, for example, the user relevance determination unit may perform quality assurance processing on the extracted keywords on the basis of Internet information. Using the keywords extracted in this way after performing the quality assurance processing, it is possible to improve the accuracy of determining whether the voice in the voice segment is related to the user.

Further, for example, the user relevance determination unit may estimate the actions of the user on the basis of predetermined information including action information of the user. In this way, it is possible to estimate the user's actions satisfactorily. In this case, for example, the predetermined information may include the position information of the user, the schedule information of the user, the ticket purchase information of the user, or the speech information of the user.

As described above, the present technology involves detecting a voice segment from an environmental sound, determining whether voice in the voice segment is related to a user, and performing control so that the voice related to the user is presented. Therefore, it is possible to reduce the risk of mishearing by users in an environment where important information is transmitted.

### BRIEF DESCRIPTION OF DRAWINGS

FIG. 1 is a diagram illustrating a state in which a voice agent as an embodiment is attached to a user.

FIG. 2 is a block diagram illustrating a specific configuration example of a voice agent.

FIG. 3 is a diagram illustrating an example of keyword extraction.

FIG. 4 is a diagram illustrating an example of compensation for missing information as quality assurance.

FIG. 5 is a diagram illustrating an example of correction of erroneous information as quality assurance.

FIG. 6 is a diagram illustrating an example of an outline of the determination of a user relevance determination unit when the current location is an airport.

FIG. 7 is a diagram illustrating an example of an outline of the determination of a user relevance determination unit when the current location is a station.

FIG. 8 is a flowchart illustrating an example of a processing procedure of a processing body unit.

FIG. 9 is a diagram for explaining a method of determining whether a user is in a mishearing mode.

FIG. 10 is a flowchart illustrating an example of a processing procedure of a processing body unit in a case where the presentation of voice is performed on the condition that the user is in a mishearing mode.

FIG. 11 is a block diagram illustrating a hardware configuration example of a computer that executes processing of a processing body unit of a voice agent according to a program.

### DESCRIPTION OF EMBODIMENTS

Hereinafter, modes for carrying out the present technology (hereinafter referred to as embodiments) will be described. The description will be made in the following order.

### 1. Embodiment

### 2. Modified Example

### 1. Embodiment

### [Voice Agent]

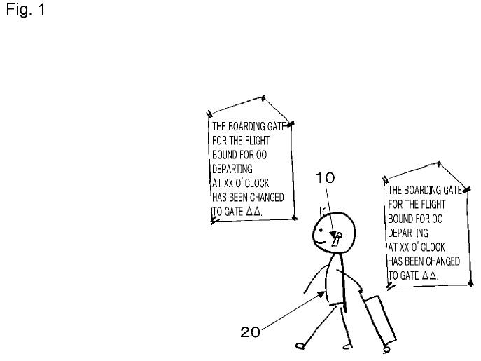

FIG. 1 illustrates a state in which a voice agent 10 as an embodiment is attached to a user 20. The voice agent 10 is attached to the user 20 in the form of earphones. The voice agent 10 detects a voice segment from an environmental sound, determines whether the voice in this voice segment is related to the user 20, and presents the voice related to the user 20 to the user 20 to reduce the risk of mishearing by the user 20.

The illustrated example assumes that user 20 is at an airport, and “The boarding gate for the flight bound for OO departing at XX o'clock has been changed to gate ΔΔ” is announced. For example, if the announcement voice is related to the user 20, the announcement voice will be reproduced and presented to the user 20. In the illustrated example, the voice agent 10 is attached to the user 20 in the form of earphones, but the attachment form of the voice agent 10 to the user 20 is not limited to this.

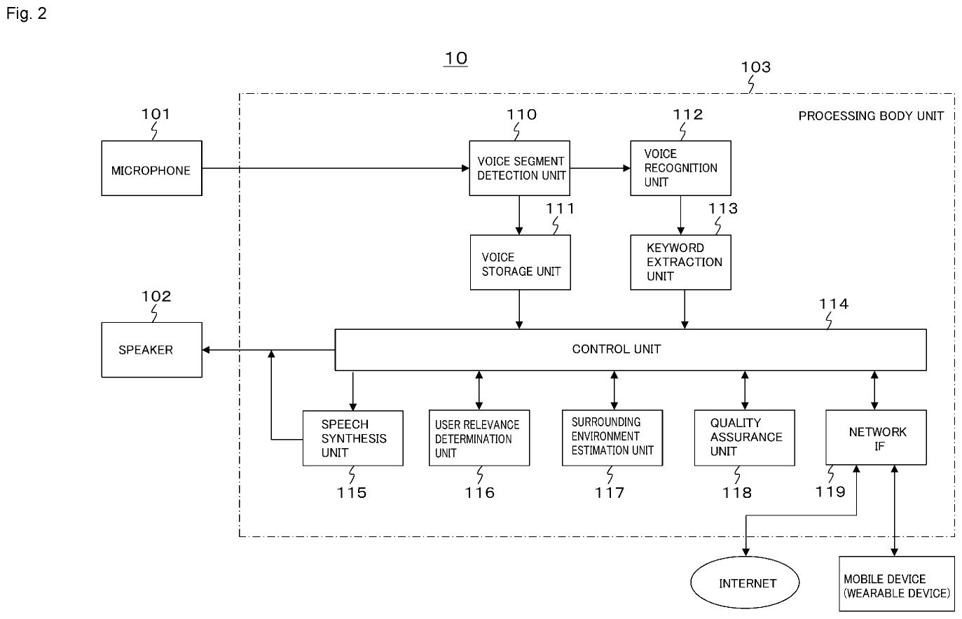

FIG. 2 illustrates a specific configuration example of the voice agent 10. The voice agent 10 has a microphone 101 as an input interface, a speaker 102 as an output interface, and a processing body unit 103. The processing body unit 103 may be configured as a cloud server.

The processing body unit 103 includes a voice segment detection unit 110, a voice storage unit 111, a voice recognition unit 112, a keyword extraction unit 113, a control unit 114, a speech synthesis unit 115, a user relevance determination unit 116, a surrounding environment estimation unit 117, a quality assurance unit 118, and a network interface (network IF) 119.

The voice segment detection unit 110 detects a voice segment from the voice data of the environmental sound obtained by collecting the sound with the microphone 101. In this case, the voice data of the environmental sound is buffered, and voice detection processing is performed thereon to detect a voice segment. The voice storage unit 111 is configured of, for example, a semiconductor memory, and stores the voice data of the voice segment detected by the voice segment detection unit 110.

The voice recognition unit 112 performs voice recognition processing on the voice data of the voice segment detected by the voice segment detection unit 110, and converts the voice data into text data. The keyword extraction unit 113 performs natural language processing on the text data obtained by the voice recognition unit 112 to extract keywords related to actions. Here, the keywords related to actions are keywords that affect the actions of the user.

For example, the keyword extraction unit 113 may be configured of a keyword extractor created by collecting a large amount of sets of text data of announcements in airports and stations and keywords to be extracted as training data and training DNN with the training data. Further, for example, the keyword extraction unit 113 may be configured of a rule-based keyword extractor that extracts keywords from grammatical rules.

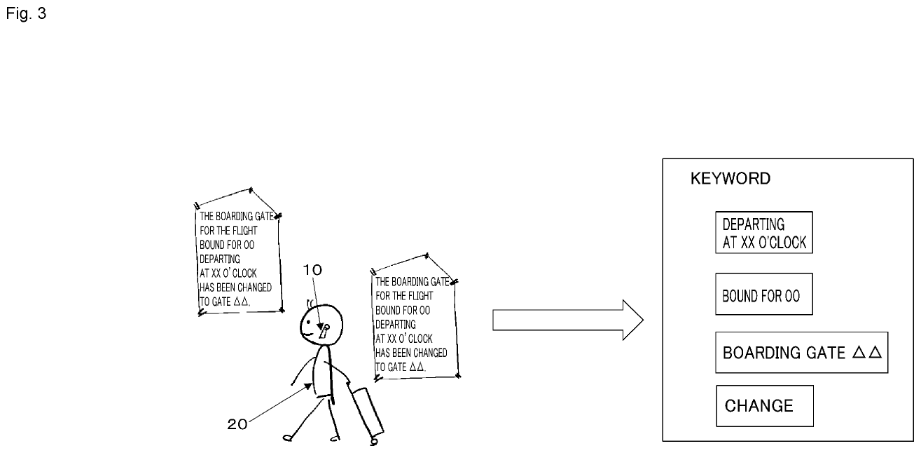

FIG. 3 illustrates an example of keyword extraction. In the illustrated example illustrates an example in which keywords are extracted from the announcement “The boarding gate for the flight bound for OO departing at XX o'clock has been changed to gate ΔΔ”. In this case, “departing at XX o'clock”, “bound for OO”, “gate ΔΔ”, and “change” are extracted as keywords related to actions.

Returning to FIG. 2, the network interface 119 is a network interface for connecting to a mobile device possessed by the user 20 or a wearable device attached to the user 20, and further connecting to various information providing sites via the Internet.

The network interface 119 acquires the position information and schedule information (calendar information) of the user 20 from the mobile device or the wearable device. The network interface 119 acquires various kinds of information (Internet information) via the Internet. This Internet information also includes airplane and railway operation information obtained from sites that provide the airplane and railway operation information.

The surrounding environment estimation unit 117 estimates the surrounding environment where the user 20 is present on the basis of the position information of the user 20 acquired by the network interface 119. The surrounding environment corresponds to airports, stations, and the like. The surrounding environment estimation unit 117 may estimate the surrounding environment on the basis of the environmental sound collected and obtained by the microphone 101 instead of the position information of the user 20. In this case, the environmental sound of stations and the environmental sound of airports may be input to a learning device with the labels “station” and “airport” assigned thereto, and the learning device may perform supervised learning. In this way, a discriminator that estimates “environment” from the environmental sound can be created and used.

The quality assurance unit 118 performs quality assurance on the keywords related to actions extracted by the keyword extraction unit 113. This quality assurance includes (1) compensation for missing information and (2) correction of incorrect information. The quality assurance unit 118 performs quality assurance on the basis of the Internet information acquired by the network interface 119. By performing quality assurance in this way, it is possible to improve the accuracy of determining whether the voice in the voice segment described later is related to the user. The quality assurance unit 118 is not always necessary, and a configuration in which the quality assurance unit 118 is not provided may be considered.

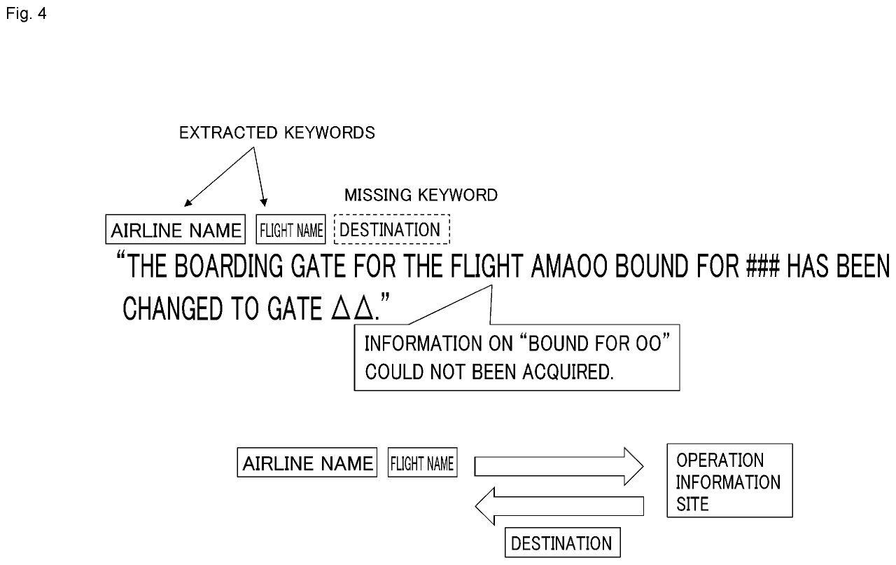

FIG. 4 illustrates an example of “(1) compensation for missing information”. In the case of the illustrated example, it is assumed that the keyword extraction unit 113 could not acquire the information (keyword of the destination) of “bound for OO” and the information is missing. In this case, the destination information of the airplane is acquired from the flight information site of the airplane by the network interface 119, and the missing destination keyword is compensated on the basis of the destination information.

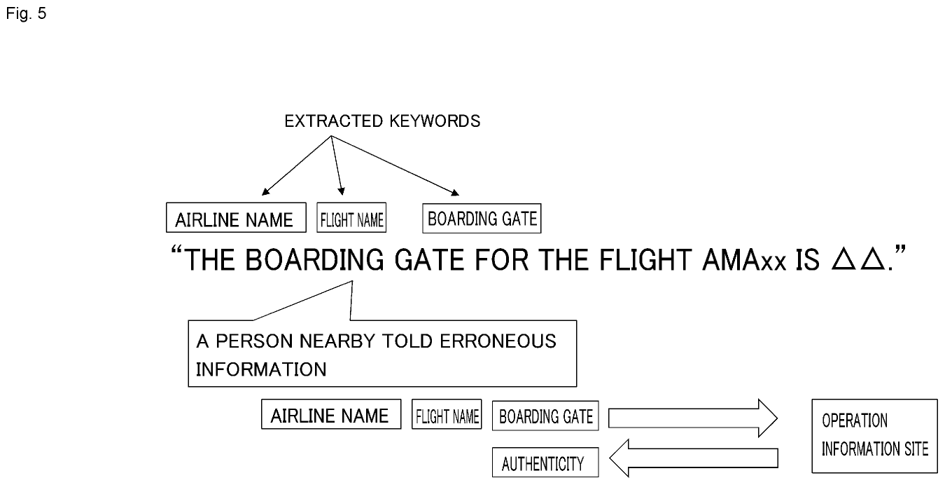

FIG. 5 illustrates an example of “(2) correction of erroneous information”. In the case of the illustrated example, it is assumed that “The boarding gate for flight AMA XX is ΔΔ” is the statement of a person near the user 20, and “boarding gate ΔΔ” is incorrect. In this case, the boarding gate information of the airplane is acquired from the flight information site of the airplane by the network interface 119, and the error of “boarding gate ΔΔ” is found on the basis of the boarding gate information and the keyword of the boarding gate is corrected correctly.

Returning to FIG. 2, it is determined whether the voice in the voice segment is related to the user. The user relevance determination unit 116 determines whether the voice in the voice segment is related to the user on the basis of the relevance between the action of the user 20 and the keywords related to actions, extracted by the keyword extraction unit 113 and quality-assured by the quality assurance unit 118.

Here, the user relevance determination unit 116 estimates the actions of the user 20 on the basis of predetermined information including the action information of the user 20. The predetermined information includes the user's position information and the user's schedule information acquired from the mobile device or the wearable device by the network interface 119, the ticket purchase information acquired from the mobile device or the wearable device by the network interface 119, or the speech information or the like of the user 20.

For example, from the position information, it is possible to determine where the current location is, for example, an airport or a station. This also corresponds to the surrounding environment information obtained by the surrounding environment estimation unit 117. Further, from the position information, for example, when the current location is a station, a route to the destination can be searched for and a line name and an inbound train/outbound train (outer loop/inner loop) can be extracted.

In addition, the destination can be extracted from the date and time in the schedule information, and if the current location is an airport, the flight number can also be extracted. In addition, information on user's actions such as date, departure time, departure place, arrival time, destination, and flight number if the ticket is an airline ticket can be extracted from the ticket purchase information (for example, a ticket purchase e-mail). In addition, the departure time, destination, and the like can be extracted from the user's speech information.

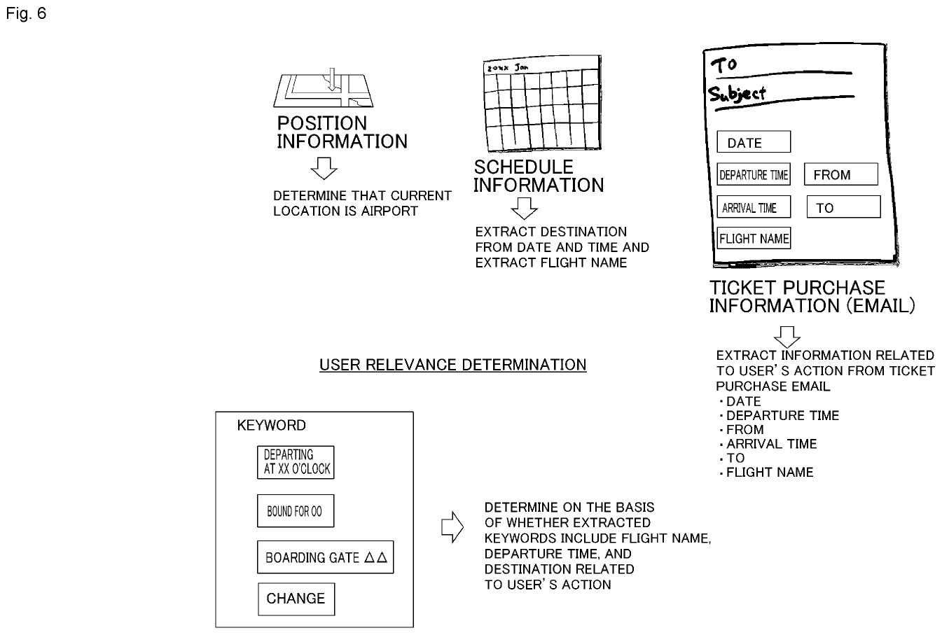

FIG. 6 illustrates an example of an outline of the determination of the user relevance determination unit 116 when the current location is an airport. In the illustrated example, position information, schedule information, and ticket purchase information (email) are used as predetermined information including the action information of the user 20. In the illustrated example, the keywords of “departing at XX o'clock”, “bound for OO”, “boarding gate ΔΔ”, and “change” are extracted.

In this case, the user relevance determination unit 116 determines that the current location indicated by the position information is an airport. In addition, the user relevance determination unit 116 extracts the destination from the date and time in the schedule information, and further extracts the flight number. In addition, the user relevance determination unit 116 extracts the date, departure time, departure place, arrival time, destination, and flight number from the ticket purchase information. Then, the user relevance determination unit 116 determines whether the voice in the voice segment is related to the user on the basis of whether the extracted keywords include the flight number, departure time, and destination related to the user's actions.

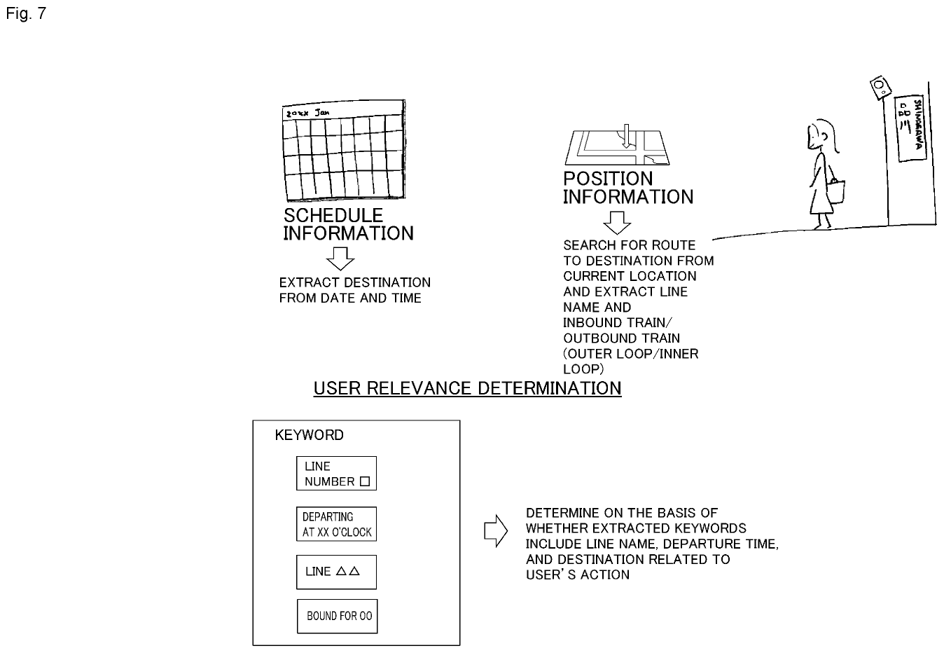

FIG. 7 illustrates an example of an outline of the determination of the user relevance determination unit 116 when the current location is a station (Shinagawa station). In the illustrated example, position information and schedule information are used as the predetermined information including the action information of the user 20. In the illustrated example, the keywords of “line number □”, “departing at XX o'clock”, “line ΔΔ”, and “bound for OO” are extracted.

In this case, the user relevance determination unit 116 extracts the destination from the date and time of the schedule information. In addition, the user relevance determination unit 116 determines that the current location indicated by the position information is a station (Shinagawa station), searches for a route from the current location to the destination, and extracts the line name and the inbound train/outbound train (outer loop/inner loop). Then, the user relevance determination unit 116 determines whether the voice in the voice segment is related to the user on the basis of whether the extracted keyword includes the line name, the departure time, and the destination related to the user's actions.

Returning to FIG. 2, the control unit 114 controls the operation of each unit of the processing body unit 103. The control unit 114 controls the presentation of the voice in the voice segment on the basis of the determination result of the user relevance determination unit 116. In this case, when it is determined that the voice in the voice segment is related to the user, the control unit 114 reads the voice data of the voice segment stored in the voice storage unit 111 and supplies the voice data to the speaker 102. As a result, the sound of the voice segment is output from the speaker 102.

The speech synthesis unit 115 is for translating and presenting the voice in the voice segment into an operation language preset in the voice agent 10 when the voice in the voice segment is different from the operation language. In this case, the speech synthesis unit 115 creates text data of the operation language from the extracted keywords, converts the text data into voice data, and supplies the voice data to the speaker 102.

In the above description, when the voice in the voice segment is presented, the voice data of the voice segment stored in the voice storage unit 111 is read, and the voice data is supplied to the speaker 102. However, a configuration in which text data is created from the extracted keywords, converted into voice data, and supplied to the speaker 102 is also conceivable. In that case, the voice storage unit 111 that stores the voice data of the voice segment is not necessary.

In the above description, when the voice in the voice segment is presented, the voice data of the voice segment stored in the voice storage unit 111 is read out, and the voice data is supplied to the speaker 102. However, it is also conceivable that text data is created from the extracted keywords and the text data is supplied to a display for display on a screen. That is, the voice in the voice segment is presented on the screen.

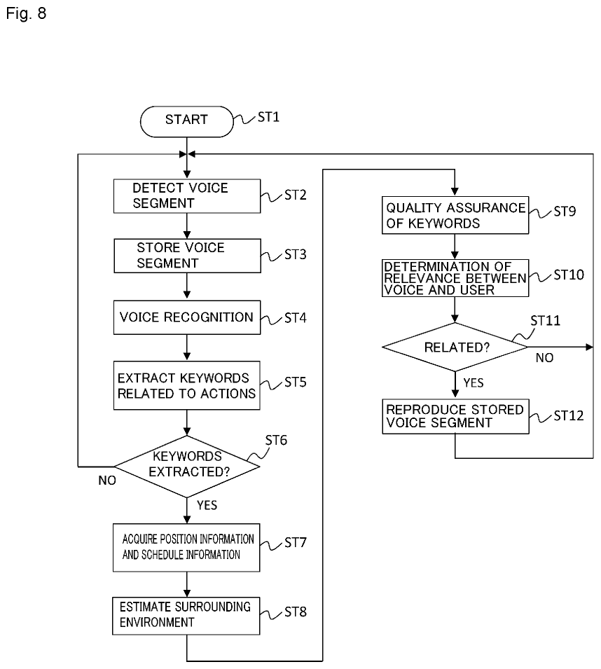

The flowchart of FIG. 8 illustrates an example of the processing procedure of the processing body unit 103. In step ST1, the processing body unit 103 starts processing. Subsequently, in step ST2, the processing body unit 103 detects a voice segment from the environmental sound collected and obtained by the microphone 101. Subsequently, in step ST3, the processing body unit 103 stores the voice data of the detected voice segment in the voice storage unit 111.

Subsequently, in step ST4, the processing body unit 103 performs voice recognition processing on the voice data of the voice segment using the voice recognition processing unit 112, and converts the voice data into text data. Subsequently, in step ST5, the processing body unit 103 performs natural language processing on the text data obtained by the voice recognition unit 113 using the keyword extraction unit 113 and extracts keywords related to actions.

Subsequently, in step ST6, the processing body unit 103 determines whether a keyword related to the action has been extracted. When the keyword is not extracted, the processing body unit 103 returns to step ST2 and detects the next voice segment. On the other hand, when the keyword is extracted, the processing body unit 103 proceeds to step ST7.

In step ST7, the processing body unit 103 acquires position information and schedule information from the mobile device or the wearable device using the network interface 119. In this case, predetermined information including ticket purchase information and other user action information may be further acquired.

Subsequently, in step ST8, the processing body unit 103 estimates the surrounding environment, that is, where the current location is (for example, an airport or a station), on the basis of the position information acquired in step ST7. In this case, the surrounding environment may be estimated from the environmental sound.

Subsequently, in step ST9, the processing body unit 103 performs quality assurance on the keywords related to the actions extracted by the keyword extraction unit 113 using the quality assurance unit 118. In this case, quality assurance is performed on the basis of the Internet information acquired by the network interface 119. This quality assurance includes (1) compensation for missing information and (2) correction of incorrect information (see FIGS. 4 and 5). If quality assurance is not performed, the process of step ST9 is not performed.

Subsequently, in step ST10, the processing body unit 103 determines the relevance of the voice in the voice segment to the user using the user relevance determination unit 116. Specifically, it is determined whether the voice in the voice segment is related to the user on the basis of the relevance between the keywords related to actions extracted by the keyword extraction unit 113 and quality-assured by the quality assurance unit 118 and the actions of the user 20 (see FIGS. 6 and 7). In this case, the actions of the user 20 are estimated on the basis of predetermined information (position information, schedule information, ticket purchase information, user speech information, and the like) including the action information of the user 20.

Subsequently, in step ST11, when the determination in step ST10 is “not related”, the processing body unit 103 returns to step ST2 and detects the next voice segment. Meanwhile, in step ST11, when the determination in step ST10 is “related”, the processing body unit 103 reads the voice data of the voice segment from the voice storage unit 111 using the control unit 114 and supplies the voice data to the speaker 102 in step ST12. As a result, the voice in the voice segment is output from the speaker 102, and the mishearing by the user 20 is reduced.

After the processing of step ST12, the processing body unit 103 returns to step ST2 and detects the next voice segment.

As described above, the processing body unit 103 of the voice agent 10 illustrated in FIG. 2 performs control so that a voice segment is detected from the environmental sound, whether the voice of this voice segment is related to the user is determined, and the voice related to the user is presented. Therefore, in an environment where important information is transmitted, it is possible to reduce the risk of mishearing by the user.

The processing body unit 103 illustrated in FIG. 2 is used after performing quality assurance processing on keywords extracted from the voice in the voice segment. Therefore, it is possible to improve the accuracy of determining whether the voice in the voice segment is related to the user.

### 2. Modified Example

In the above-described embodiment, an example in which the processing body unit 103 of the voice agent 10 presents the voice in the voice segment related to the user regardless of the user's mode. However, it is also conceivable that this voice presentation is performed on condition that the user is in a mishearing mode.

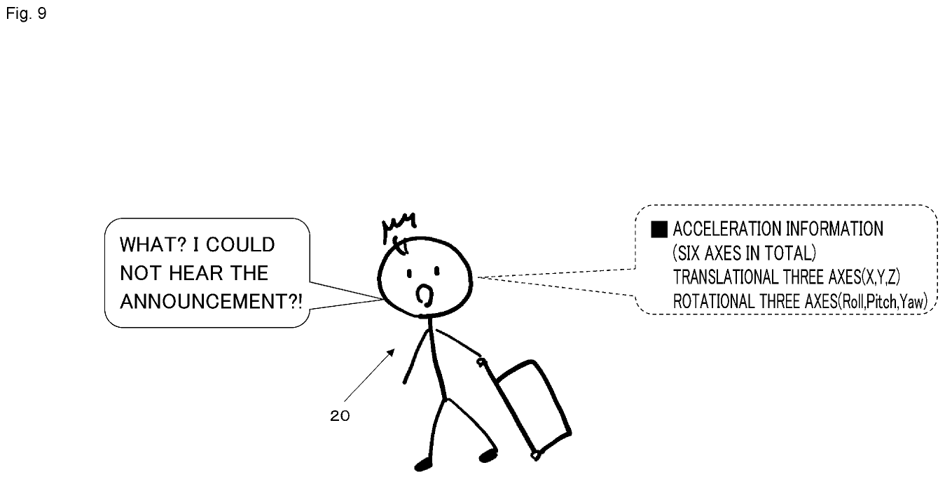

Whether the user 20 is in the mishearing mode can be determined on the basis of the acceleration information acquired from the voice agent device (earphone) and the speech information of the user 20, for example, as illustrated in FIG. 9. In this case, the movement information of the head of the user 20 (acceleration information of 6 axes) when the announcement is misheard is prepared as training data, and a “mishearing mode” is learned by supervised learning to create a discriminator. At this time, the speech information of the user 20 may be learned together to create a discriminator. Alternatively, a learning device may be created only with the speech information of the user 20. By inputting the acceleration information and the environmental sound information acquired from the voice agent device to this discriminator, it is determined whether the user is in a mishearing mode.

Whether the user 20 is in the mishearing mode may be determined using other information instead of using the movement information of the head of the user 20 and the speech information. For example, it is conceivable to determine from biological information such as the pulse and brain waves of the user 20.

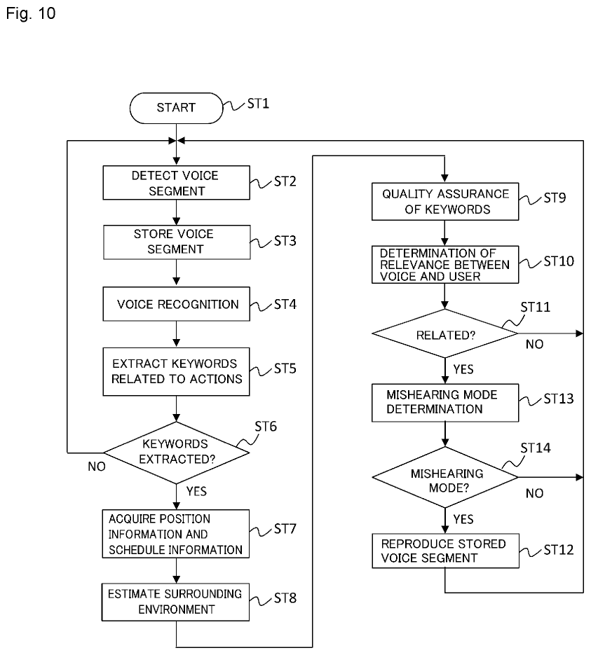

The flowchart of FIG. 10 illustrates an example of the processing procedure of the processing body unit 103 in the case where the presentation of the voice is performed on condition that the user is in a mishearing mode. In FIG. 10, portions corresponding to those in FIG. 8 are denoted by the same reference signs, and description thereof will be appropriately omitted.

When the determination in step ST11 is “related”, the processing body unit 103 determines in step ST13 whether the user is in the mishearing mode. Subsequently, in step ST14, when the determination in step ST13 is “not in the mishearing mode”, the processing body unit 103 returns to step ST2 and detects the next voice segment. On the other hand, in step ST14, when the determination in step ST13 is “in the mishearing mode”, the processing body unit 103 proceeds to step ST12, and reads the voice data of the voice segment from the voice storage unit 111 and supplies the voice data to the speaker 102 using the control unit 114, and then, the process returns to step ST2.

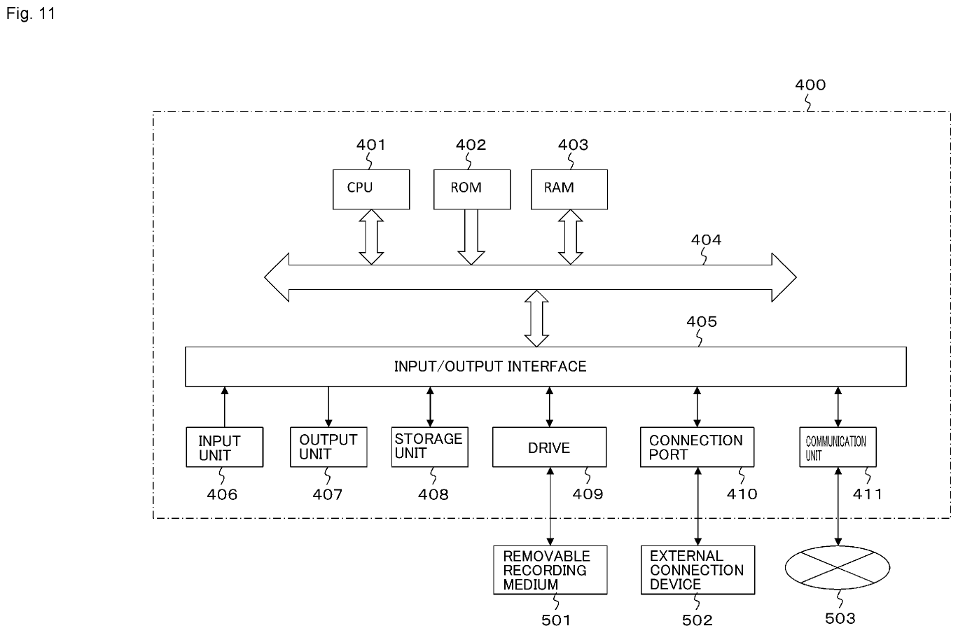

FIG. 11 is a block diagram illustrating a hardware configuration example of a computer 400 that executes the processing of the processing body unit 103 of the voice agent 10 described above according to a program.

The computer 400 includes a CPU 401, a ROM 402, a RAM 403, a bus 404, an input/output interface 405, an input unit 406, an output unit 407, a storage unit 408, a drive 409, a connection port 410, and a communication unit 411. The hardware configuration illustrated herein is an example, and some of the components may be omitted. Further, components other than the components illustrated herein may be further included.

The CPU 401 functions as, for example, an arithmetic processing device or a control device, and controls all or some of the operations of the components on the basis of various programs recorded in the ROM 402, the RAM 403, the storage unit 408, or a removable recording medium 501.

The ROM 402 is a means for storing a program read into the CPU 401, data used for calculation, and the like. In the RAM 403, for example, a program read into the CPU 401, various parameters that change as appropriate when the program is executed, and the like are temporarily or permanently stored.

The CPU 401, ROM 402, and RAM 403 are connected to each other via the bus 404. On the other hand, the bus 404 is connected to various components via the interface 405.

For the input unit 406, for example, a mouse, a keyboard, a touch panel, buttons, switches, levers, and the like are used. Further, as the input unit 406, a remote controller capable of transmitting a control signal using infrared rays or other radio waves may be used.

The output unit 407 is, for example, a device capable of notifying users of acquired information visually or audibly, such as a display device such as a CRT (Cathode Ray Tube), an LCD, or an organic EL, an audio output device such as a speaker or a headphone, a printer, a mobile phone, a facsimile, or the like.

The storage unit 408 is a device for storing various types of data. As the storage unit 408, for example, a magnetic storage device such as a hard disk drive (HDD), a semiconductor storage device, an optical storage device, a magneto-optical storage device, or the like is used.

The drive 409 is a device that reads information recorded on the removable recording medium 501 such as a magnetic disk, an optical disk, a magneto-optical disk, or a semiconductor memory, or writes information to the removable recording medium 501.

The removable recording medium 501 is, for example, a DVD medium, a Blu-ray (registered trademark) medium, an HD DVD medium, various semiconductor storage media, and the like. Naturally, the removable recording medium 501 may be, for example, an IC card equipped with a non-contact type IC chip, an electronic device, or the like.

The connection port 410 is a port for connecting an external connection device 502 such as a USB (Universal Serial Bus) port, an IEEE1394 port, a SCSI (Small Computer System Interface), an RS-232C port, or an optical audio terminal. The external connection device 502 is, for example, a printer, a portable music player, a digital camera, a digital video camera, an IC recorder, or the like.

The communication unit 411 is a communication device for connecting to the network 503, and is, for example, a communication card for wired or wireless LAN, Bluetooth (registered trademark), or WUSB (Wireless USB), a router for optical communication, a router for ADSL (Asymmetric Digital Subscriber Line), or a modem for various communications.

The program executed by the computer may be a program that performs processing chronologically in the order described in the present specification or may be a program that performs processing in parallel or at a necessary timing such as a calling time.

Although the preferred embodiments of the present disclosure have been described in detail with reference to the accompanying figures as described above, the technical scope of the present disclosure is not limited to such examples. It is apparent that those having ordinary knowledge in the technical field of the present disclosure could conceive various modified examples or changed examples within the scope of the technical ideas set forth in the claims, and it should be understood that these also naturally fall within the technical scope of the present disclosure.

The present technology may also be configured as follows.

(1) An information processing device including: a voice segment detection unit that detects a voice segment from an environmental sound, a user relevance determination unit that determines whether voice in the voice segment is related to a user, and a presentation control unit that controls presentation of the voice in the voice segment related to the user.
(2) The information processing device according to (1) above, wherein the user relevance determination unit extracts keywords related to actions from the voice in the voice segment, and determines whether the voice in the voice segment is related to the user on the basis of relevance of the extracted keywords to actions of the user.
(3) The information processing device according to (2) above, wherein the user relevance determination unit uses the extracted keywords after performing quality assurance processing.
(4) The information processing device according to (3) above, wherein the quality assurance includes compensation for missing information or correction of incorrect information.
(5) The information processing device according to (3) or (4) above, wherein the user relevance determination unit performs quality assurance processing on the extracted keywords on the basis of Internet information.
(6) The information processing device according to any one of (2) to (5) above, wherein the user relevance determination unit estimates the actions of the user on the basis of predetermined information including action information of the user.
(7) The information processing device according to (6) above, wherein the predetermined information includes position information of the user.
(8) The information processing device according to (6) or (7) above, wherein the predetermined information includes schedule information of the user.
(9) The information processing device according to any one of (6) to (8) above, wherein the predetermined information includes ticket purchase information of the user.
(10) The information processing device according to any one of (6) to (9) above, wherein the predetermined information includes speech information of the user.
(11) The information processing device according to any one of (1) to (10) above, wherein the presentation control unit controls presentation of the voice related to the user when the user is in a mishearing mode.
(12) An information processing method including procedures of: detecting a voice segment from an environmental sound, determining whether voice in the voice segment is related to a user, and controlling presentation of the voice in the voice segment related to the user.

### REFERENCE SIGNS LIST

10 Voice agent
20 User
101 Microphone
102 Speaker
103 Processing body unit
110 Voice segment detection unit
111 Voice storage unit
112 Voice recognition unit
113 Keyword extraction unit
114 Control unit
115 Speech synthesis unit
116 User relevance determination unit
117 Surrounding environment estimation unit
118 Quality assurance unit
119 Network interface

1. An information processing device comprising:
a voice segment detection unit that detects a voice segment from an environmental sound,
a user relevance determination unit that determines whether voice in the voice segment is related to a user, and
a presentation control unit that controls presentation of the voice in the voice segment related to the user.

2. The information processing device according to claim 1, wherein
the user relevance determination unit extracts keywords related to actions from the voice in the voice segment, and determines whether the voice in the voice segment is related to the user on the basis of relevance of the extracted keywords to actions of the user.

3. The information processing device according to claim 2, wherein
the user relevance determination unit uses the extracted keywords after performing quality assurance processing.

4. The information processing device according to claim 3, wherein
the quality assurance includes compensation for missing information or correction of incorrect information.

5. The information processing device according to claim 3, wherein
the user relevance determination unit performs quality assurance processing on the extracted keywords on the basis of Internet information.

6. The information processing device according to claim 2, wherein
the user relevance determination unit estimates the actions of the user on the basis of predetermined information including action information of the user.

7. The information processing device according to claim 6, wherein
the predetermined information includes position information of the user.

8. The information processing device according to claim 6, wherein
the predetermined information includes schedule information of the user.

9. The information processing device according to claim 6, wherein
the predetermined information includes ticket purchase information of the user.

10. The information processing device according to claim 6, wherein
the predetermined information includes speech information of the user.

11. The information processing device according to claim 1, wherein
the presentation control unit controls presentation of the voice related to the user when the user is in a mishearing mode.

12. An information processing method comprising procedures of:
detecting a voice segment from an environmental sound,
determining whether voice in the voice segment is related to a user, and controlling presentation of the voice in the voice segment related to the user.
